(19) United States
(12) Patent Application Publication
(10) Pub. No.: US 2026/0028090 A1
(43) Pub. Date: Jan. 29, 2026

(54) KIT FOR THE ELECTRIC CONVERSION OF A COMBUSTION MOTORCYCLE

(71) Applicant: BETTELLA S.r.l., Limena (PD) (IT)

(72) Inventor: Vittorio ZITUN, Limena (PD) (IT)

(73) Assignee: BETTELLA S.r.l., Limena (PD) (IT)

(21) Appl. No.: 18/994,334

(22) PCT Filed: Jul. 14, 2023
(86) PCT No.: PCT/IB2023/057230

§ 371 Date: Jan. 14, 2025

(30) Foreign Application Priority Data
Jul. 15, 2022 (IT) 102022000014860

(51) Int. Cl. B62M 7/00; B62K 11/00; B62M 11/02

(52) U.S. Cl. CPC B62M 7/00; B62K 11/00; B62M 11/02; B62K 2204/00

(57) ABSTRACT

A kit for the electric conversion of a combustion motorcycle, the motorcycle comprising an internal combustion engine provided with a bedplate which defines a chamber adapted to house a crankshaft assembly, and a connecting portion adapted to connect to a cylinder, and compring an electric motor adapted to be associated with said connecting portion, a drive shaft configured to be housed at least partly in said chamber and to be connected to a mechanical transmission of the motorcycle and a transmission system adapted to be positioned between said electric motor and said drive shaft and configured to transmit a driving torque from said electric motor to said drive shaft.

### TECHNICAL FIELD

The present invention relates to a kit for the electric conversion of a combustion motorcycle.

### BACKGROUND ART

The present invention is in the area of electric conversion of motorcycles having an internal combustion engine. This operation is commonly referred to as “retrofitting” and involves the use of special conversion kits that, when properly built into the motorcycle, allow an electrical conversion to take place.

The present invention finds preferred, but not exclusive, application in the context of the conversion of those motorcycles commonly referred to as “collector's” motorcycles, i.e., motorcycles that have aesthetic characteristics which are particularly appreciated by specific categories of enthusiast consumers. An example of such a type of motorcycle is the Vespa® scooter produced by Piaggio & C., whose design is one of the most famous in the world.

In this context, electric conversion is usually done by completely removing the internal combustion engine and replacing it with a new electric motor or a special wheel having a built-in electric motor.

However, such known solutions always fail to meet the needs of the aforementioned enthusiast consumers, as the removal of the original motor deeply alters the aesthetic characteristics of the motorcycle, consequently changing its design. Therefore, such an electric conversion fails to meet the needs of the enthusiast consumer.

In addition to this, known solutions are characterized by being “direct-drive” on the motorcycle wheel and, as a result, require the removal or make unusable the mechanical gear transmission already present in the motorcycle.

Such known conversion systems are also difficult to manufacture, erratic in operation and extremely expensive.

### DESCRIPTION OF THE INVENTION

The Applicant envisioned developing a special electric conversion kit adapted to be built within the internal combustion engine of a motorcycle, thus allowing the latter's aesthetic characteristics to remain substantially unchanged.

The main aim of the present invention, therefore, is to make a kit for the electric conversion of a combustion motorcycle that allows the latter's aesthetic characteristics to remain unchanged.

Another object of the present invention is to make a kit for the electric conversion of a motorcycle which is easy to use and inexpensive.

Another object of the present invention is to make a kit for the electric conversion of a combustion motorcycle capable of implementing a circular economy system, that is, a system wherein there is the reuse of materials in subsequent production cycles, thus reducing waste to a minimum.

Another object of the present invention is to devise a kit for the electric conversion of a motorcycle which allows the aforementioned drawbacks of the prior art to be overcome within the framework of a simple, rational, easy and efficient to use as well as affordable solution.

The aforementioned objects are achieved by this kit for the electric conversion of a combustion motorcycle having the characteristics of claim 1.

The aforementioned objects are achieved by this method for the electric conversion of a combustion motorcycle having the characteristics of claim 8.

The aforementioned objects are achieved by this electrically converted motorcycle having the characteristics of claim 10.

### BRIEF DESCRIPTION OF THE DRAWINGS

Other characteristics and advantages of the present invention will become more apparent from the description of a preferred, but not exclusive, embodiment of a kit for the electric conversion of a combustion motorcycle, illustrated by way of an indicative yet non-limiting example, in the accompanying tables of drawings in which:

FIG. 1 is a side view of the kit associated with the internal combustion engine of a motorcycle in accordance with the present invention,

FIG. 2 is a sectional view of the kit in FIG. 1,

FIGS. 3 and 4 are views of the crankshaft and drive axle of the kit in FIG. 1,

FIG. 5 is an exploded view of the kit applied to the combustion engine.

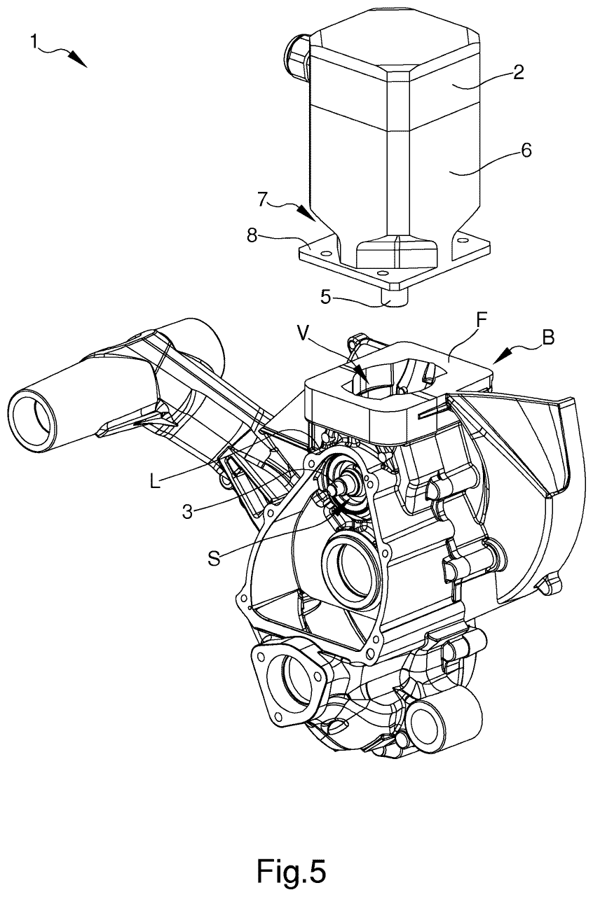

### EMBODIMENTS OF THE INVENTION

With particular reference to these figures, reference numeral 1 globally indicates a kit for the electric conversion of a combustion motorcycle.

Such a kit 1 is designed to be applied, preferably, to a Vespa scooter®, by the company Piaggio & C. It cannot however be ruled out that such a kit 1 could be applied to a different type of motorcycle or motor vehicle in general.

The motorcycle, not shown in its entirety in the figures, to which the kit 1 according to the invention is applicable, is provided with an internal combustion engine. Such internal combustion engine is operatively connected to at least one wheel by means of a mechanical transmission configured to transmit a torque from the internal combustion engine to the wheel.

Preferably, the motorcycle is provided with at least one rear wheel and at least one front wheel. However, a different configuration of the motorcycle where, e.g., there are more or fewer wheels and/or where the engine is operatively connected to a different number of wheels cannot be ruled out.

The operation of a motorcycle provided with an internal combustion engine is particularly well known in the state of the art and therefore will not be explored in detail in the remainder of this description. Similarly, the components and operation of an internal combustion engine are also known in the state of the art and therefore will not be explored in detail.

As shown in the examples of the attached figures, the internal combustion engine is provided with a bedplate B adapted to support and/or enclose the engine's mechanical parts.

The internal combustion engine also comprises a cylinder, associated with the bedplate B, adapted to house a piston in a sliding manner.

The combustion engine is also normally provided with a drive shaft assembly. Such a drive shaft assembly has its own shaft mounted to the bedplate B in a rotoidal manner and a crank system located between the piston and the shaft to convert the reciprocating motion of the piston into a rotary motion of the shaft. The mechanical transmission of the motorcycle is operatively connected to the drive shaft assembly so as to transmit the rotary motion of the latter to the motorcycle wheel.

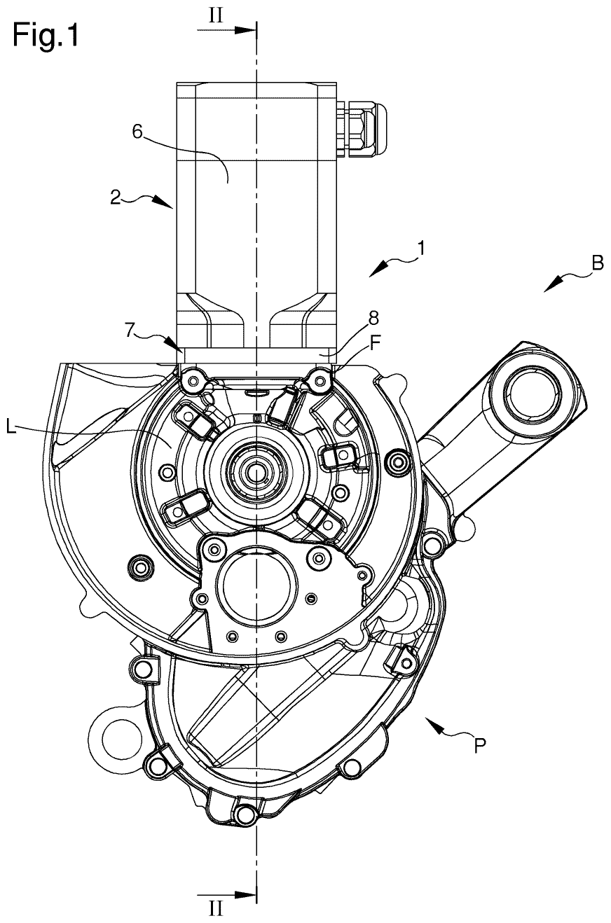

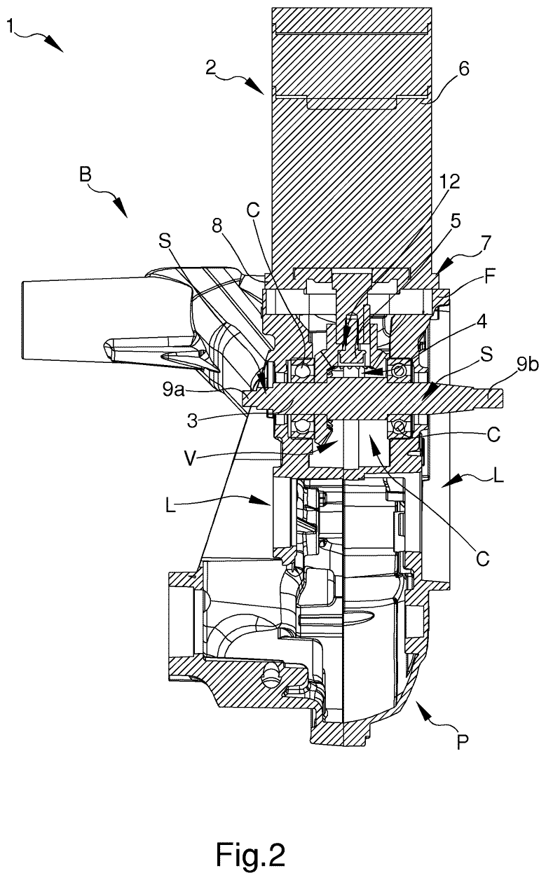

As visible from FIGS. 1 and 2, the bedplate B defines a chamber C adapted to house the drive shaft assembly. Such a chamber C is commonly known as the “crank chamber” and, together with a portion of the cylinder, is part of the so- called “pump casing”.

Furthermore, the bedplate B defines a connecting portion F adapted to connect to the cylinder. This connecting portion F is arranged where the chamber C is located. Additionally, the connecting portion F has an opening adapted to connect the chamber C with the interior of the cylinder, allowing the crank system to extend between the piston and the shaft.

In the present case, the chamber C comprises a compartment V within which the drive shaft assembly is placeable. In addition, the cylinder comprises a respective compartment in which the piston is placeable.

The connecting portion F is, in use, located between the cylinder and the chamber C so that the opening can connect the compartment V of the chamber C to the cylinder compartment.

The connecting portion F has a substantially flat shape. Preferably, the connecting portion F has a substantially square or rectangular surface.

In addition, the connecting portion F comprises fastening means configured to allow the fastening to the cylinder. Specifically, the fastening means have one or more holes cut on the connecting portion F adapted to receive a fastener, such as e.g. a screw.

As visible from FIG. 2, the chamber C is bounded laterally by a pair of lateral walls L and above by the connecting portion F.

Each lateral wall L comprises a seat S configured to accommodate a portion of the shaft and constrain it in a rotoidal manner. Such seats S are commonly referred to as “bench supports” and have a circular shape with a diameter corresponding to the portion of the shaft they are to accommodate.

At least one of the seats S is provided with a through hole which allows a portion of the shaft to escape from the chamber C. Preferably, each seat S has a respective through hole. The portion of the shaft that escapes from the chamber C is connected to the mechanical transmission and/or to a flywheel and/or to a cooling fan.

Each seat S comprises a bearing C adapted to support the shaft in a rotoidal manner.

Additionally, the bedplate B comprises a housing portion P configured to house a mechanical transmission. The mechanical transmission is, in use, positioned between the shaft and the wheel and/or an axle. Such a housing portion P is commonly known as the “transmission casing”.

The bedplate B has a pair of shells that can be coupled together, preferably in a removable manner. For this purpose, the bedplate B has closure means that can be associated with the two shells to join them together. Specifically, the closure means are configured to tighten the shells in order to fasten them together.

As visible from FIG. 1, the bedplate B has a substantially circular pump casing with which a flywheel housing portion is associated, on one side and, on the other side, a transmission housing portion P of the casing. In particular, the flywheel housing is arranged where a seat S of the chamber C is located so as to allow the shaft end to be connected to the flywheel. In addition, the housing portion P of the transmission is arranged where the other seat S of the chamber C is located so as to allow the connection of the other end of the shaft to the mechanical transmission.

The cylinder is connected superiorly to the bedplate B. Specifically, the cylinder is opposite the transmission casing with respect to the chamber C.

FIG. 2 details the kit of the electric conversion associated with an internal combustion engine of a motorcycle.

The kit 1 comprises:
an electric motor 2 adapted to be associated with the connecting portion F of the internal combustion engine, and 30
a drive shaft 3 configured to be housed at least partly in the chamber C and to be connected to a mechanical transmission of the motorcycle.

In actual facts, the electric motor 2 is connectable to the connecting portion F so as to replace the original cylinder of the internal combustion engine. Similarly, the drive shaft 3 can be housed in the chamber C so as to replace the drive shaft assembly that was previously mounted in the chamber C.

Conveniently, the kit 1 comprises a transmission system 4 adapted to be positioned between the electric motor 2 and the drive shaft 3. The transmission system 4 is configured to transmit a driving torque from the electric motor 2 to the drive shaft 3.

To summarize, after the kit 1 has been mounted to the internal combustion engine, the drive shaft 3 is arranged in the chamber C to replace the drive shaft assembly, the electric motor 2 is mounted to the connecting portion F to replace the cylinder, and the transmission system 4 is positioned between the electric motor 2 and the drive shaft 3 to replace the crank system. The kit 1 according to the invention is extremely easy to mount onto an internal combustion engine and allows the remaining operation of the motorcycle as well as its appearance not to vary significantly.

As visible from FIG. 2, the electric motor 2 comprises a rotating drive axle 5. In addition, the electric motor 2 is provided with an electric actuator, not shown in the figures, operatively connected to the drive axle 5. The electric actuator, when passed through by an electric current, is configured to rotate the drive axle 5.

The operation of an electric motor 2 is known in the state of the art and therefore will not be discussed in detail in the remainder of this description.

The electric motor 2 then comprises an enclosure 6. The enclosure 6 is adapted to enclose the electric actuator. The drive axle 5, on the other hand, protrudes for a distance from the enclosure 6. The drive axle 5 can thus be connected, via the transmission system 4, to the drive shaft 3. The transmission system 4, as we shall see in detail later in the description, is configured to transform the rotary motion of the drive axle 5 into a rotary motion of the drive shaft 3.

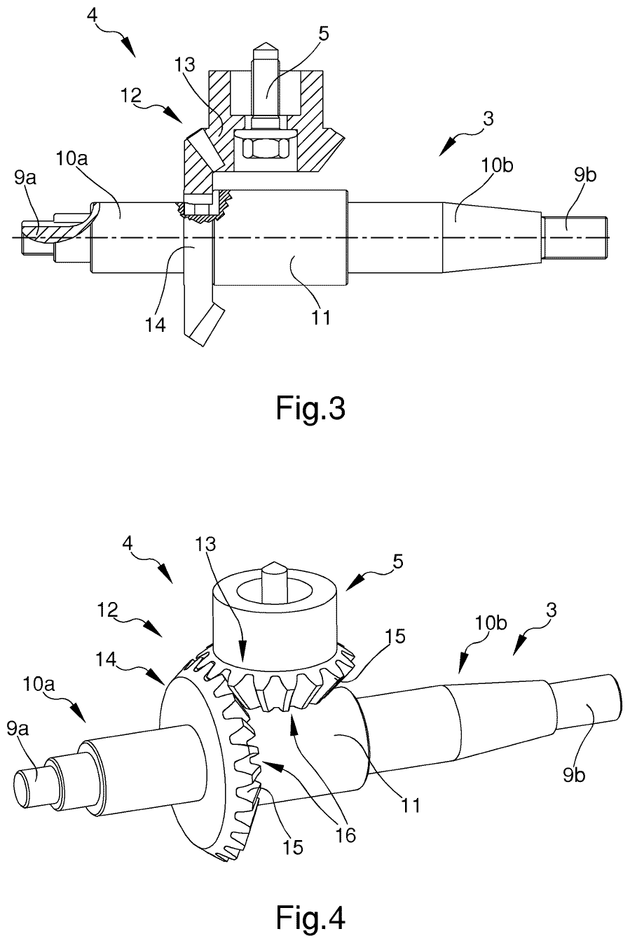

As can be seen from FIGS. 3 and 4, when mounted on the internal combustion engine, the drive axle 5 and the drive shaft 3 are intended to be arranged transversely to each other. Specifically, in use, the drive axle 5 and the drive shaft 3 are intended to be arranged substantially perpendicular to each other.

Appropriately, the kit 1 comprises connecting means 7 adapted to be arranged between the connecting portion F and the electric motor 2. The connecting means 7 are configured to attach the electric motor 2 to the connecting portion F. In particular, the connecting means 7 are configured to attach the electric motor 2 to the internal combustion engine so as to arrange a portion of the drive axle 5 internally to the chamber C. Thus, the transmission system 4 can be placed between the drive axle 5 and the drive shaft 3. Therefore, in use, the electric motor 2 and the drive shaft 3 can be connected to each other through the passage opening of the connecting portion F, which is usually intended for the passage of the crank system or of the piston of the internal combustion engine.

The connecting means 7 comprise a flange element 8 configured to be attached to the electric motor 2 and to the connecting portion F. Specifically, the flange element 8 is locked together with the electric motor 2. In addition, the flange element 8 is adapted to be associated with the connecting portion F.

For this purpose, the flange element 8 has a shape that is substantially complementary to the connecting portion. Specifically, the flange element 8 is specially designed to have a shape complementary to the connecting portion F of the internal combustion engine with which the kit 1 is to be associated. This expedient makes it possible to connect a given electric motor 2 to any type of bedplate B.

Preferably, the flange element 8 has a substantially flat shape. Even more preferably, the flange element 8 has a substantially square or rectangular surface.

Additionally, the flange element 8 has an opening adapted to allow the passage of the drive axle. Furthermore, the connecting means 7 comprise at least one hole cut on the flange element 8 adapted to receive a fastener for attaching the flange element 8 to the connecting portion F. Preferably, the hole has a thread and the fastener is of the type of a screw.

As visible in FIG. 4, the drive shaft 3 mainly extends along its own longitudinal direction between a pair of ends 9a, 9b.

Preferably, the drive shaft 3 has a substantially cylindrical shape. In other words, the drive shaft 3 has a substantially circular cross section.

Preferably, the drive shaft 3 has a pair of connecting portions 10a, 10b, each being arranged at one end 9a, 9b.

Each connecting portion 10a, 10b is configured to make a rotoidal coupling with the chamber C. Specifically, each connecting portion 10a, 10b is configured to be housed in a seat S of the chamber C to make a rotoidal coupling.

For this purpose, each connecting portion 10a, 10b has a diameter that is substantially complementary to the diameter of the seat S in which it is intended to be housed.

Preferably, the ends 9a, 9b of the drive shaft 3 have a diameter less than or equal to the diameter of the connecting portion 10a, 10b so that they can pass through the seat of the chamber C to project therefrom. The ends 9a, 9b can thus be connected to a mechanical transmission of the motorcycle and/or to a flywheel and/or to a cooling fan.

Appropriately, the drive shaft 3 has a transmission portion adapted to be connected to the transmission system 4. The transmission portion 11 is located between the pair of connecting portions 10a, 10b. In actual facts, the transmission portion 11 is arranged in a substantially central position.

As visible from FIG. 4, the transmission portion 11 comprises a larger diameter than that of the connecting portions 10a, 10b.

As anticipated above, the transmission system 4 is configured to transform the rotation of the drive axle 5 into a rotation of the drive shaft 3.

For this purpose, the transmission system 4 comprises at least one gear 12 adapted to be positioned between the electric motor 2 and the drive shaft 3.

Preferably, the gear 12 is configured to transform the motion generated by the electric motor 2 into a rotary motion of the drive shaft 3. Preferably, the gear 12 is positioned between the drive axle 5 and the drive shaft 3 and is configured to transform the rotary motion of the drive axle 5 into a rotary motion of the drive shaft 3.

The possibility that the electric motor 2 may be of the linear type, i.e., configured to generate a linear motion, and the gear 12 be configured to transform the linear motion of the electric motor into a rotary motion of the drive shaft 3 cannot, however, be ruled out.

As seen in FIG. 4, the gear 12 comprises a first gear wheel 13 associated with the drive axle 5 and a second gear wheel 14 associated with the drive shaft 3. The gear wheels 13, 14 are configured to mesh with each other in order to transmit the rotary motion of a gear wheel 13, 14 to the other.

Preferably, the first gear wheel 13 is arranged where one end of the drive axle 5 is located. Instead, the second gear wheel 14 is arranged where the transmission portion 11 of the drive shaft 3 is located. Specifically, the second gear wheel 14 is arranged against a stop surface of the drive shaft 3. The stop surface is made by the difference in diameter between the transmission portion 11 and one of the connecting portions 10a, 10b.

Since the drive axle 5 and the drive shaft 3 are arranged transversely to each other, the gear wheels 13, 14 are configured to couple to each other by means of a bevel gear.

Specifically, each gear wheel 13, 14 is adapted to rotate around its own axis of rotation. The first and second gear wheels 13, 14 are associated with the drive axle 5 and with the drive shaft 3 respectively, so that their axis of rotation substantially coincides with that of the drive axle 5 and of the drive shaft 3, respectively.

Each gear wheel 13, 14 has a lateral surface 15 which winds substantially circularly to its respective axis of rotation. In addition, each gear wheel 13, 14 has a set of teeth 16 arranged on the lateral surface 15. The teeth 16 of each gear wheel 13, 14 are adapted to engage with the teeth 16 of the other gear wheel 13, 14.

Each gear wheel 13, 14 has a substantially conical shape. In other words, the lateral surface 15 is inclined with respect to the respective axis of rotation by a predetermined angle.

The angle of inclination of the gear wheels is predefined as a function of the opening angle defined between the drive axle 5 and the drive shaft 3. Specifically, the angle of inclination is such that, in use, the gear wheels 13, 14 can mesh with each other in order to transmit the rotary motion.

In this case, the sum of the angles of inclination of the two gear wheels 13, 14 is substantially similar to the opening angle between the drive axle 5 and the drive shaft 3.

For example, in the event of the opening angle between the drive axle 5 and the drive shaft 3 being substantially 90°, the angle of inclination of each gear wheel 13, 14 is substantially 45°.

Appropriately, the first gear wheel 13 is locked together with the drive axle 5 so as to rotate locked together with the latter. Similarly, the second gear wheel 14 is locked together with the drive shaft 3 so as to rotate locked together with the latter.

The present invention also relates to a method for the electric conversion of a combustion motorcycle.

This method involves setting up a motorcycle provided with an internal combustion engine and a kit 1 in accordance with what was described above.

The method involves accommodating the drive shaft 3 of the kit 1 in the chamber C.

This is done by placing the connecting portions of the drive shaft 3 in the seats S of the chamber C.

The method also involves connecting the electric motor 2 to the connecting portion F. The connection is made by arranging at least one portion of the drive axle 5 of the electric motor 2 internally into the chamber C so that it is positioned where the drive shaft 3 is located.

The method also involves positioning the transmission system 4 between the electric motor 2 and the drive shaft 3. In this case, the end of the drive axle 5 is arranged where the drive shaft 3 is located so that the first and the second gear wheels 13, 14 are made to mesh with each other.

Before mounting the kit 1 onto the internal combustion engine, it is useful to check whether the latter is provided with its own drive shaft assembly housed in the chamber C and/or with a cylinder connected to the connecting portion F.

In the case where the drive shaft assembly is present, the method comprises a step of removing that drive shaft assembly from the chamber C.

In the case where the cylinder is present, the method comprises a step of removing that cylinder from the connecting portion F. The removal of the cylinder preferably also involves the removal of additional components associated therewith, such as the piston, crank system and so on.

It may also happen that the internal combustion engine has a fuel injection system and/or an exhaust system. In such a case, preferably, the method involves the additional step of removing the fuel injection system and/or the exhaust system.

After the kit 1 has been mounted to the internal combustion engine, the method comprises a step of connecting the drive shaft 3 to the motorcycle's mechanical transmission.

FIG. 2 shows an internal combustion engine converted into an electric motor using this kit and/or this conversion method. From that figure, it can be seen how the electric motor 2 is mounted to the connecting portion F of the internal combustion engine to replace the cylinder and the drive shaft 3 is housed in the chamber C to replace the drive shaft assembly.

The electric motor 2 is mounted to the connecting portion F in such a way as to allow the drive axle 5 to pass through the opening of the connecting portion F to arrange itself internally to the chamber C. In this way, the gear 12 of the transmission system 4 is also arranged internally to the chamber C.

The drive shaft 3 is also housed in the chamber C so that its ends 9a, 9b protrude from the seats thereof. One end is thus connected to the flywheel and/or to the cooling fan of the combustion engine, while the other end is connected to the mechanical transmission of the internal combustion engine.

The present invention also relates to an electrically reconverted motorcycle. Such a motorcycle comprises a frame, not shown in the figures, and an internal combustion engine mounted to the frame. In addition, the motorcycle comprises at least one wheel associated with the frame in a rotoidal manner, in this case two wheels, and a mechanical transmission placed between the internal combustion engine and the wheel.

The motorcycle also comprises the kit 1 mounted to the internal combustion engine as described above.

It has in practice been ascertained that the described invention achieves the intended objects, and in particular, the fact is emphasized that by means of the kit according to the present invention it is possible to carry out an electric conversion of an internal combustion motorcycle while keeping the aesthetic characteristics of the latter unchanged by means of a simple, effective and affordable solution.

1. A kit for electric conversion of a combustion motorcycle, said combustion motorcycle comprising.
an internal combustion engine provided with a bedplate which defines:
a chamber adapted to house a crankshaft assembly, and
a connecting portion adapted to connect to a cylinder;
an electric motor adapted to be associated with said connecting portion,
a drive shaft configured to be housed at least partly in said chamber and to be connected to a mechanical transmission of the combustion motorcycle, and
a transmission system adapted to be positioned between said electric motor and said drive shaft and configured to transmit a driving torque from said electric motor to said drive shaft.

2. The kit according to claim 1, wherein:
said electric motor comprises a rotating drive axis, and
said transmission system is configured to transform the a rotary motion of said drive axle into a rotary motion of said drive shaft.

3. The kit according to claim 2, wherein said transmission system comprises at least one gear adapted to be positioned between said drive axle and said drive shaft.

4. The kit according to claim 3, wherein said gear comprises a first gear wheel associated with said drive axle and a second gear wheel associated with said drive shaft, said gear wheels being configured to mesh with each other.

5. The kit according to claim 4, wherein said gear wheels are configured to couple to each other by means of a bevel gear.

6. The kit according to claim 1, further comprising connecting means adapted to be arranged between said connecting portion and said electric motor and configured to attach the electric motor to said connecting portion.

7. The kit according to claim 6, wherein said connecting means comprise a flange element configured to be attached to said electric motor and to said connecting portion.

8. A method for electric conversion of a combustion motorcycle, comprising:
setting up a motorcycle provided with an internal combustion engine comprising:
a chamber adapted to house a drive shaft assembly, and
a connecting portion to a cylinder;
setting up the kit according to claim 1
accommodating said drive shaft in said chamber;
connecting said electric motor to said connecting portion; and
positioning said transmission system between said electric motor and said drive shaft.

9. The method according to claim 8, further comprising:
checking whether said internal combustion engine has its own drive shaft assembly housed in said chamber and/or a cylinder connected to said connecting portion,
removing said drive shaft assembly if said drive shaft assembly exists, and
removing said cylinder if said cylinder exists.

10. An electric reconverted motorcycle, comprising:
a frame,
at least one wheel associated with said frame in a rotary manner,
an internal combustion engine mounted on said frame and provided with a chamber adapted to house a drive shaft assembly, and with a connecting portion to a cylinder,
a mechanical transmission positioned between said internal combustion engine and said wheel, and
said kit according to claim 1, wherein said electric motor is connected to said connecting portion, said drive shaft is housed in said chamber, said transmission system is positioned between said electric motor and said drive shaft, said mechanical transmission is operatively connected to said drive shaft.
